(19) United States
(12) Patent Application Publication
(10) Pub. No.: US 2024/0093679 A1
(43) Pub. Date: Mar. 21, 2024

(54) POWER ENGINE

(71) Applicant: Dharmendra Kumar, Bengaluru (IN)

(72) Inventor: Dharmendra Kumar, Bengaluru (IN)

(21) Appl. No.: 18/038,313

(22) PCT Filed: Nov. 23, 2021
(86) PCT No.: PCT/IB2021/060853

§ 371 Date: May 23, 2023

(30) Foreign Application Priority Data
Nov. 23, 2020 (IN) 202041050956

(51) Int. Cl. F03G 7/10

(52) U.S. Cl. CPC F03G 7/119

(57) ABSTRACT

A power engine for amplifying one or more sets of attributes such as torque and force is disclosed. The power engine unit includes a first system, a second system, and a compressor system. The first system includes a crankshaft wheel and the first set of cylinders, wherein the crankshaft flywheel is configured on one side of the first set of cylinders to provide a heavy circular output from the linear motion. The second system includes a second set of cylinders and a set of pistons corresponding to the second set of cylinders. The second set of cylinders are coupled to the first set of cylinders. The compressor system is coupled with the first set of cylinders and the second set of cylinders, where the compressor system includes a first cylinder hole to allow the flow of compressor oil from the first set of cylinders of the first system.

### TECHNICAL FIELD

The present disclosure relates to power engines. In particular, the present disclosure pertains to power engines that amplify one or more sets of attributes such as torque and force.

### BACKGROUND

Background description includes information that may be useful in understanding the present invention. It is not an admission that any of the information provided herein is prior art or relevant to the presently claimed invention, or that any publication specifically or implicitly referenced is prior art.

As known in the art, there are a variety of engines such as petrol or diesel engines that can be driven by mechanical energy, electrical energy, petroleum and so on. However, it is understood that the construction of such engines is very complicated, prevents easy service, and consumes primary energy sources. In addition, such engines suffer with poor efficiency.

There is therefore a need in the art for a power engine, which overcomes above-mentioned and other limitations of existing engines.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY

The present disclosure generally relates to power engines. In particular, the present disclosure pertains to power engines that amplify one or more sets of attributes such as torque and force.

In an aspect, the present disclosure provides a power engine unit that includes a first system comprising a crankshaft wheel and the first set of cylinders. The crankshaft flywheel is configured on one side of the first set of cylinders to provide a heavy circular output from the linear motion; a second system comprising a second set of cylinders, and a set of pistons corresponding to the second set of cylinders, wherein the second set of cylinders are coupled to the first set of cylinders; and a compressor system coupled with the first set of cylinders and the second set of cylinders, the compressor system comprising a first cylinder hole to allow the flow of compressor oil from the first set of cylinders of the first system.

In an embodiment, the power engine unit comprises a fourth system comprising a converter wheel coupled with the flywheel of the first system, where the coupling of the flywheel with the converter wheel allows the transfer of power from the first system to the fourth system.

In an embodiment, the power engine unit comprises a fifth system configured as a supporting power system and a sixth system configured as an additional power system.

In an embodiment, the first system includes a linear piston set to allow to &fro linear circular motion inside a cylinder chamber of the first set of cylinders, wherein the linear piston set is connected with the fourth system, and wherein the linear piston set is configured to perform push-pull movement inside the first set of cylinders with compressor oil.

In an embodiment, the first system includes a flywheel to couple with a heavy load of the pulley, gears, belt, chains as an output system.

In an embodiment, the first system includes a penium shaft on another side of the first set of cylinders, wherein the penium shaft is configured with a handle, wherein the penium shaft is configured to convert the rotation of the handle into a linear movement to allow movement of the linear piston set inside the first set of cylinders.

In an embodiment, the second system includes a shocker spring configured to allow smooth movement of second set cylinders with a crankshaftflywheel.

In an embodiment, the second system includes connecting rod plates coupled with the shocker spring, wherein the connecting rod plates are configured to connect connecting rod of the second set of cylinders with each other, to collect the input-output power evenly.

In an embodiment, the second system includes a cylinder plate configured to hold the second set of cylinders.

In an embodiment, the second set of cylinders and corresponding pistons are arranged in rows and columns adjacent closed to each other, and wherein each of the second set of cylinders is smaller in size as compared to the first set of cylinders.

Various objects, features, aspects, and advantages of the inventive subject matter will become more apparent from the following detailed description of preferred embodiments, along with the accompanying drawing figures in which like numerals represent like components

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 illustrates an exemplary representation of a first system of the proposed power engine, in accordance with embodiments of the present disclosure.

FIG. 2 illustrates an exemplary representation of a second system of the proposed power engine, in accordance with embodiments of the present disclosure.

FIG. 3 illustrates an exemplary representation of the compressor system of the power engine, in accordance with embodiments of the present disclosure.

FIG. 4 illustrates an exemplary representation of the fourth system of power engine coupled with the first system, in accordance with embodiments of the present disclosure.

FIG. 5 illustrates motion line flow diagram, in accordance with embodiments of the present disclosure.

FIG. 6 illustrates motion line layers of the power engine or power system, in accordance with embodiments of the present disclosure.

FIGS. 7A and 7B illustrate configurations of the first system and the second system, in accordance with embodiments of the present disclosure.

FIG. 8 illustrates power engine testing strategy, in accordance with embodiments of the present disclosure.

FIGS. 9A-9C illustrate the first power engine unit, second power engine unit, and third power engine unit of the power engine, respectively, in accordance with embodiments of the present disclosure.

FIGS. 10A and 10B illustrate an exemplary representation of a waveform of power engine and mode of power engine, respectively, in accordance with embodiments of the present disclosure.

FIG. 11 illustrates an exemplary graphical representation of power multiplier factor of the power engine, in accordance with embodiments of the present disclosure.

FIGS. 12A and 12B illustrate an exemplary representation of the clustering of the first system, the second system, the third system, and the fourth system, in accordance with embodiments of the present disclosure.

FIGS. 13A-13F illustrate various views of power engine, in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Various terms are used. To the extent a term in the present disclosure is not defined, it should be given the broadest definition persons in the pertinent art have given that term as reflected in printed publications and issued patents at the time of filing.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

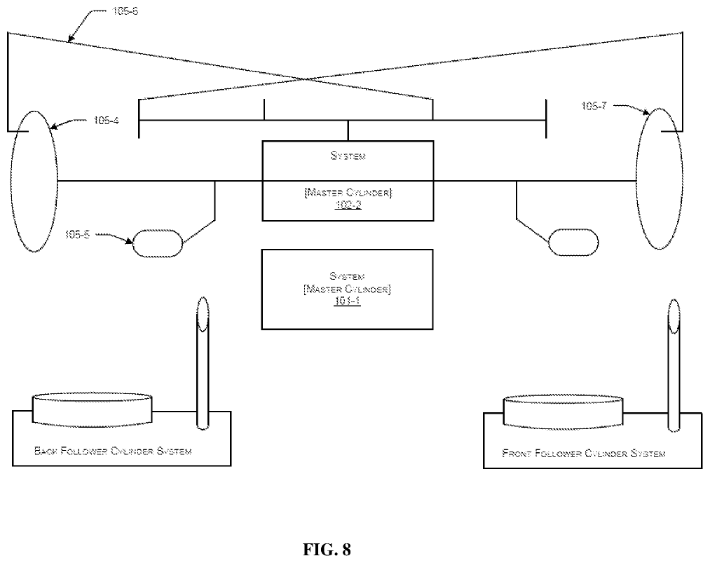

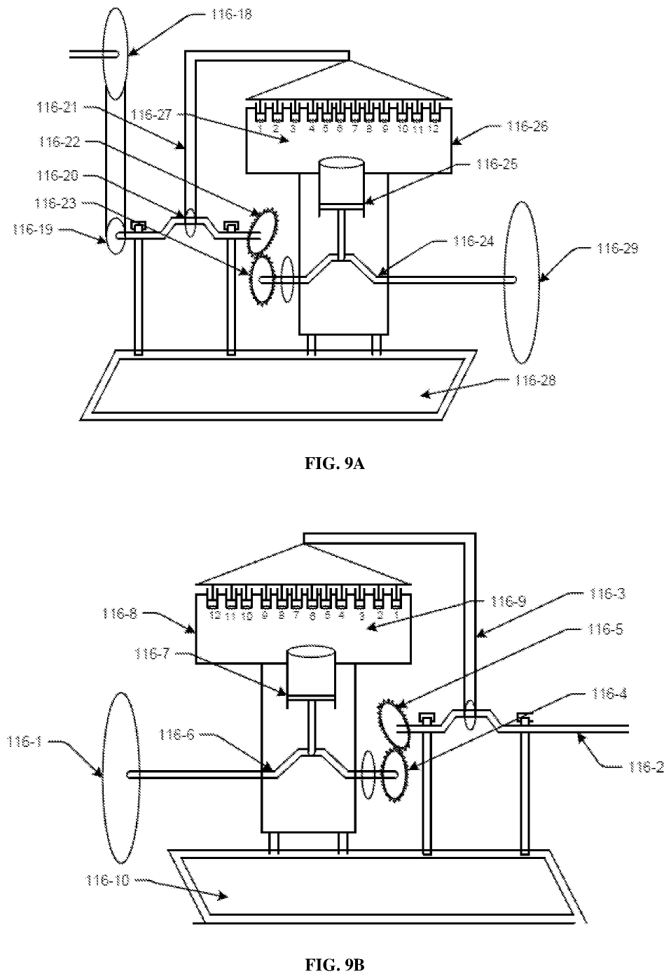

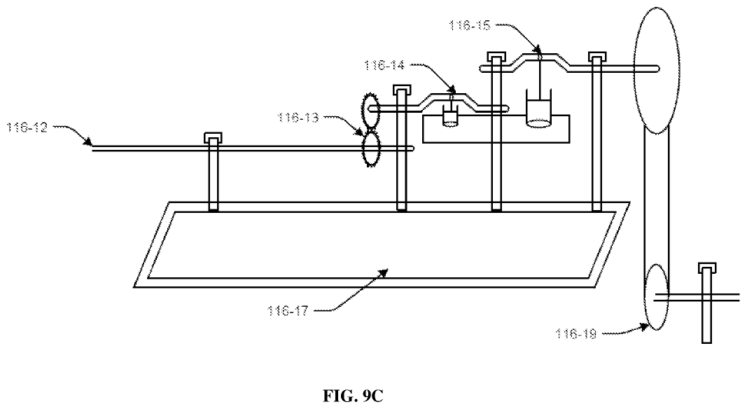

Embodiments of the present disclosure relate to power engine(PE) (also referred to as “Power System”, “Power Machine”, “Power Setup”, “Self Power”, “Auto Power”, “Power Tool”, “Power Box”, “Power Pack”, “Power Appliances”, “Power Alternator”, “Power Resource”, “Power Battery”, “Power Inverter”, “Power Convertor”, “Power Controller”, “Power Generator”, or “Universal Power”), particularly a set of systems connected toamplify one or more sets of attributes such as torque and force, where the amplification includes conversion of one or more attributes such as torque, force, and so on from a low value to a higher value. The proposed power engine is configured as alternative renewable energy resourceful pollution free self-powered engine. The power engine works based on p-system. The power engine (interchangeably referred to as a power system)includes a first power engineunit, a second power engine unit, and a third power engine unit (collectively referred to as power engine units or power engine units). The power engine may include six types of systems—a first system or system 1, a second systemor system 2, a third system or system 3, a fourth system or system 4, a fifth system or system 5, and a sixth system or system 6. The power engine unit may include one or more such systems. Each of the first and second power engine units may include a first system, a second system, a third system. The configuration of the first power engine unit is reciprocal or similar of the configuration of the third power engine unit (see FIG. 9). The second power engine unit may include a fourth system, a fifth system, and a sixth system. The first system may be configured as a bigger cylinder-piston arrangement, whereas the second system may be configured as a set of smaller cylinder-piston systems. The third system may be configured as an input-output ratio divider system. The fourth system may be configured as an external power supply system, whereas the fifth system may be configured as a supporting power system. The sixth system may be configured as an additional power system.

In an aspect, the power engine unit includes a first system, a second system, and a third system. Additionally, the power engine unit may also include a fourth system, a fifth system, and a sixth system. The proposed power engine unit can be any of the first power engine unit, the second power engine unit, and the third power engine unit. The power engine may generate a large amount of heat. For dissipation of heat, an existing cooling system or an improved cooling system may be employed.

Conservation of energy Existing Theory: A consequence of the law of conservation of energy is that a perpetual motion machine of the first kind cannot exist, that is to say, no system without an external energy supply can deliver an unlimited amount of energy to its surroundings. For systems which do not have time translation symmetry, it may not be possible to define conservation of energy.

Conservation of energy innovated Theory: A consequence of the law of conservation of energy is that a perpetual motion machine of the first kind cannot exist, that is to say, no system without an external energy or internal energy supply can deliver an unlimited amount of energy to its surroundings. For systems which do not have time translation symmetry, it may be possible to define conservation of energy.

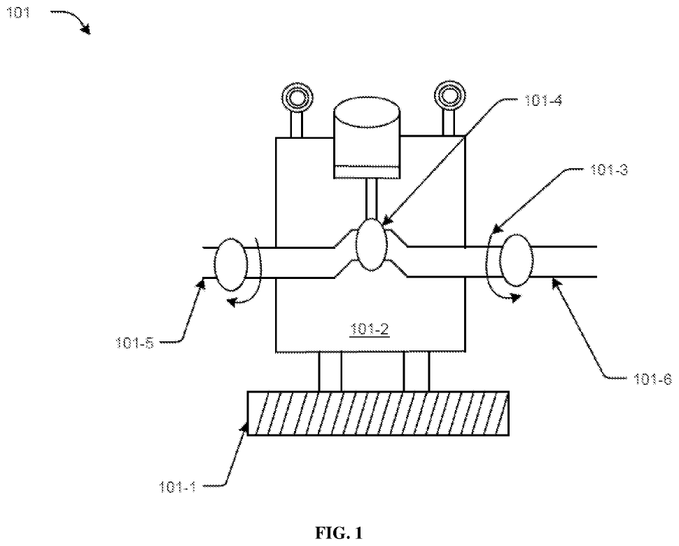

FIG. 1 illustrates an exemplary representation of a first system of the proposed power engine unit, in accordance with embodiments of the present disclosure. As illustrated in FIG. 1, the first system 101 may include a first set of cylinders, where the first set of cylinders may include, by way of example but not limited to, may include one cylinder as shown in FIG. 1. The first system 101 may include a base element 101-1 that may be configured to support all the components. In an exemplary embodiment, the base element 101-1 may be an iron plate. The first set of cylinders 101-2may be configured on the base element 101-1. The first set of cylinders 101-1 may provide support and configuration for various components of the first system 101such as linear piston connecting rod, crankshaft, flywheel, and heavy load components.

In an embodiment, the first system 101 may include a crankshaft flywheel 101-3 that may be configured on one side of the first set of cylinders 101-2 to provide a heavy circular output from the linear motion, whereas the first system 101 may include a penium shaft 101-5 on another side of the first set of cylinders 101-2. The penium shaft 101-5 may be configured with a handle that can be operated by a user. The user may rotate the handle to provide the push-pull force to provide mechanical energy, which may act as an external source for the power engine. The handle may be rotated for a predetermined time period. The penium shaft 101-5 may convert the rotation of the handle into a linear movement to allow movement of the piston set 101-4 inside the cylinder.

In an embodiment, the first system 101 may include a linear piston set 101-4 to allow to &fro linear circular motion inside a cylinder chamber of the first set of cylinders 101-2. The linear piston set 101-4 may be connected with the fourth system i.e. a compressor box. The linear piston set 101-4 may perform push-pull movement inside the first set cylinder 101-2 with compressor oil having low pressure and high power. The first system may include a flywheel 101-6 to couple with a heavy load of the pulley, gears, belt, chains as an output system. The first system may amplify one or more mechanical parameters such as force, torque. It has a two-way input-output motion connection system.

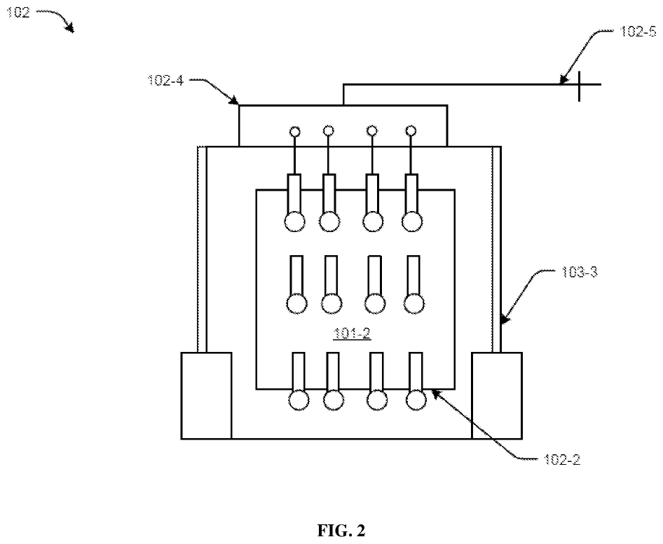

FIG. 2 illustrates an exemplary representation of a second system of the proposed power engine unit, in accordance with embodiments of the present disclosure. As illustrated in FIG. 1, the second system 102 may be configured as a crankshaft wheel input-output with a second cylinder set. The second system 102 may include a cylinder plate 102-1 that may be configured to hold a second set of cylinders 102-2. In an example, the second set of cylinders 102-2 may include 12 cylinders. However, it would be appreciated by a person skilled in the art that the second set of cylinders 102-2 may include any number of cylinders depending on various parameters of the first cylinder such as volume, power, speed, compression ratio, and so on. The second system 102 may include a set of pistons corresponding to the second set of cylinders, where the set of piston-cylinder arrangements may be arranged in rows and columns adjacent closed to each other. In an example, when there are twelve cylinders, the set of pistons may be arranged in three rows and four columns. The first cylinder may be bigger than each of the second set of cylinders.

In an embodiment, the second system 102 may include a shocker spring 102-3 that may be configured to allow smooth movement of second set cylinders with a crankshaft flywheel. In other words, the shocker spring 102-3 may absorb any jerks and shocks, thereby protecting the piston set from being damaged. The shocker spring 102-3may be connected with a compressor box. The second system 102may also include connecting rod plates 102-4 that are coupled with the shocker spring 102-3. The connecting rod plates may connect the connecting rod of the second set of cylinders with each other, to collect the input-output power evenly. The second system 102 may include a crankshaft 102-5 connected to the fourth system or converter system 104.

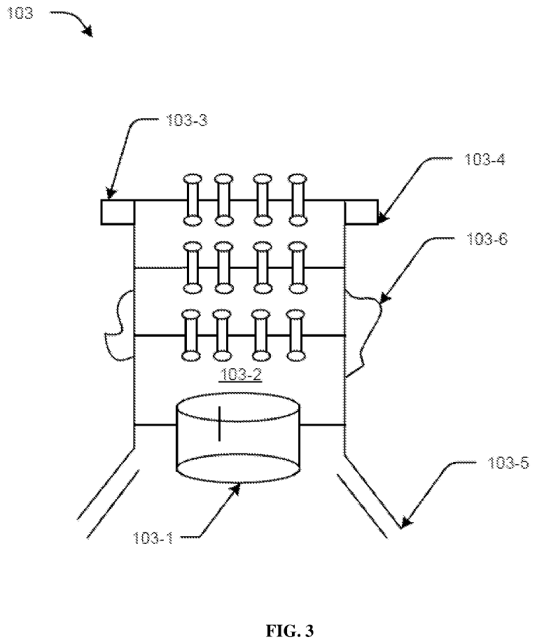

FIG. 3 illustrates an exemplary representation of a compressor system 103 of the power engine unit, in accordance with embodiments of the present disclosure. As illustrated in FIG. 3, the compressor system 103(interchangeably referred to as the third system) may include a first cylinder hole 103-1 to flow compressor oil in high volume flow from the first set of cylinders of the first system. The compressor system 103 may also include a second cylinder hole 103-2 attached with a plate in an open container inside. The second cylinder hole 103-2 may be smaller than the first cylinder hole 103-1. The third system 103may include a cylinder hole plate 103-3 that may be configured to hold the second cylinder hole slots to flow the compressor oil with high pressure.

In an embodiment, the third system 103may include shocker connecting slots 103-4, a fitting stand 103-5, and a handle 103-6. The shocker connecting slots 103-4 may be configured to hold the shocker set. Thefittingstand103-5 may be configured to couple the compressor box with the first set of cylinders of the first system and the second set of cylinders of the second system. The handle 103-6 may be configured to hold the compressor to raise or lower the compressor for fitting & unfitting with other systems.

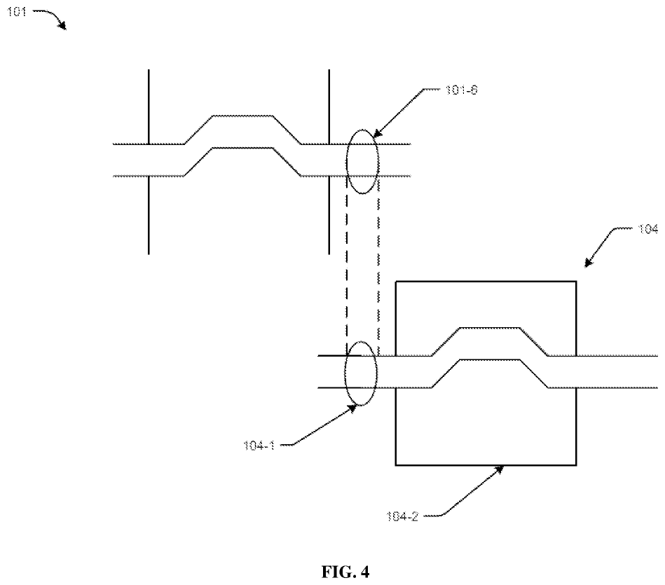

FIG. 4 illustrates an exemplary representation of a fourth system of power engine unit coupled with the first system, in accordance with embodiments of the present disclosure. The fourth system 104 may also be referred to as a converter system. As illustrated in FIG. 4, the fourth system may include a converter wheel 104-1 and a converter system 104-2. The power converter wheel 104-1 may be coupled with the flywheel of the first system. The coupling of the flywheel with the converter wheel 104-1 allows the transfer of power from the first system to the fourth system 104. The converter system 104-2 may be configured to step down values of one or more attributes such as force and torque.

FIG. 5 illustrates motion line flow diagram, in accordance with embodiments of the present disclosure. FIG. 5 indicates motion flow direction between systems. The systems 3.1 and 3.2 are the front side and backside of the third system. The systems 4.1 and 4.2 are the front side and backside of the fourth system. The systems 5.1 and 5.2 are the front side and backside of the fifth system. The systems 6.1 and 6.2 are the front side and backside of system 6. Motion Line 1 is formed between the first system and the second system. Motion Line 2 is formed between the second system and the third system. Motion Line 3 is formed between the third system and the fourth system. Motion Line 4 is formed between the fourth system and the fifth system. Motion Line 5 is formed between the fifth system and the sixth system. Bold motion line 1 is indicating the primary motion line. Divider motion line 2 is indicating the power ratio motion line. Supply motion line 3 is indicating an external power supply motion line. Support motion line 4 is indicating a supporting power motion line. Add-ons motion line 5 is indicating an additional motion line.

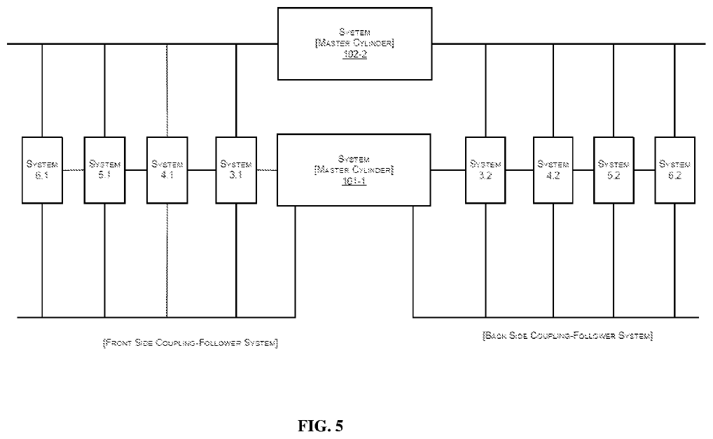

FIG. 6 illustrates motion line layers of the power engine unit, in accordance with embodiments of the present disclosure. It shows the layer's propagation from the core unit to the supporting system and vice versa. The core unit is aligned in the center of the motion line layers. Inflow and outflow motion is performed between the core unit and the first system. The layer is formed between subsequent systems. For example, motion line 1 is formed between the first system and second system, and so on.

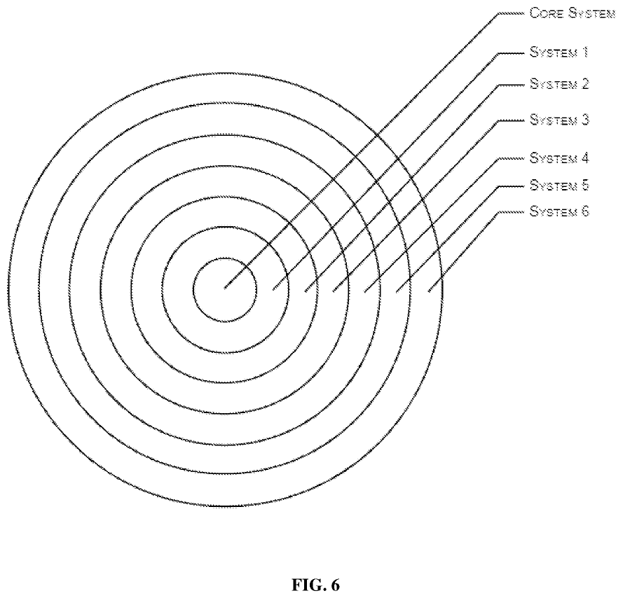

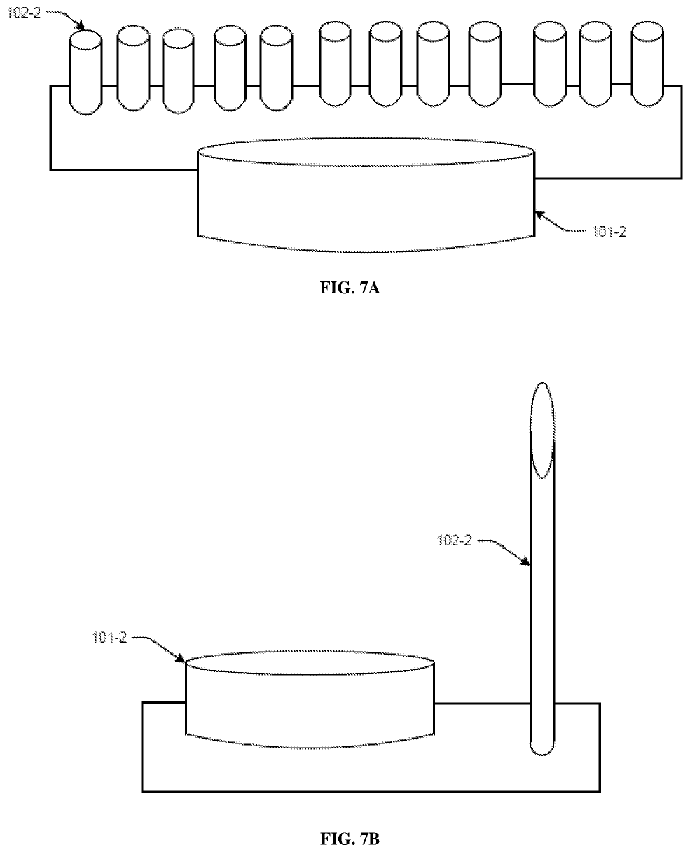

FIG. 7A illustrates a configuration of the first system with the second system, in accordance with embodiments of the present disclosure. The combination of the first system and the second system is shown to communicate with all the other systems. The power engine is tested and verified at each possible scenario individual system and combination of systems and results are successful positive. The cylinder 101-2 of the first system is coupled to the second set of cylinders 102-2 of the second system 102.

FIG. 7B illustrates another configuration of the first system with the second system, in accordance with embodiments of the present disclosure. Follower cylinder systems as shown in FIG. 107. It follows the master cylinder system instruction. It is similar to the master cylinder system but smaller in size and has less operating capacity. It is associated with other systems. As shown in FIG. 7B, bigger cylinder 101-2 of system 1 is configured with smaller cylinder 102-2.

FIG. 8 illustrates power engine testing strategy, in accordance with embodiments of the present disclosure. It highlights the following result-oriented Testing Strategy.
1) By handle from the backside.
2) By handle from the front side.
3) By crank from the front side.
4) Push left right on top center.
5) Push left right on the top end.
6) By wheel from the front side.
7) By wheel from the backside.
8) By flywheel from master cylinder system.
9) By wheel from follower cylinder system.
10) By lever-handle from the front side.
11) By lever-handle from the backside.

All the testing strategies results are successful and positive as expected for the power engine. The results are measured in terms of force, torque, weight, load, speed, time, power, length, area, radius, materialstrength, friction, volume, pressure, co mpressor, rotation, etc.

FIGS. 9A-9C illustrate the first power engine unit, second power engine unit, and third power engine unit of the power engine, respectively, in accordance with embodiments of the present disclosure. The proposed power engine unit may be any one of the first power engine unit, the second power engine unit, and the third power engine unit. As illustrated in FIG. 9A, elements 116-1 to 116-11 is the part of first power engine unit. As illustrated in FIG. 9B, 116-12 to 116-18 is the part of second power engine unit. As illustrated in FIG. 9C, 116-19 to 116-29 is the part of third power engine unit.

In an embodiment, the first power engine unit may include a large size wheel 116-1configured to rotate the first system manually. In an example, the wheel 116-1 may have an approximately 40-inch diameter. It is the initial point to start the process of the power engine. The first power engine unit may further include a crankshaft 116-2 configured to exert mechanical energy (ME) to the first system &second system. It splits mechanical energy into two parts and exerts one part of the mechanical energy on the first system and the second part of the mechanical energy on the second system. The first system transforms the mechanical energy through gears.

The first power engine unit may include connecting rod 116-3 configured to provide combined mechanical energy to the second system on top of the pistons assembly. The first power engine unit may also include gears 116-4 that transform mechanical energy and passes to the first system. The first power engine unit may also include flywheel crankshaft 116-5 of the first system configured to transform mechanical energy. The first power engine unit may also include chamber 116-6 to support the first system and the second system. The first power engine unit may also include pistons116-7 to exert the mechanical energy on compressive oil lubricants in the compressor system. It converts the mechanical energy to Fluids Energy (FE). In an exemplary embodiment, the piston's diameter may be approx. 5 inch. The piston's length maybe approx. 10 inch. In some other embodiments, the piston's length & diameter may vary.

The first power engine unit may also include a compressor box 116-8 to hold the piston of the first system and pistons of the second system. The compressor box may be part of the first system as well as the second system. It contains compressive oil lubricants and forms the compression between the first system & the second system. It forms two-way compression with respect to the first system &second system.

In an embodiment, the first power engine unit may include piston assembly 116-9 of the second system, arranged in particular rows and columns. In an exemplary embodiment, the piston assembly 116-9 includes 12 pistons arranged in 3 rows and four columns and placed on top of the compressor system. The piston's diameter of the second system is smaller as compared to the piston's diameter of the first system. The diameter of the piston of the second system may be approx. 2 inches. The height of the piston of the second system may be approx. 4 inches.

In an embodiment, the first power engine unit may include an iron plate 116-10 configured to hold the first system, second system, and third system of the first power engine unit on the ground or base level in the very efficient space & strong connecting slots.

In an embodiment, the first power engine unit may include a large wheel 116-11 configured to pass combined mechanical energy of the first system, second system, and third system to the fourth system. The large wheel 116-11 may be configured at the backside of the first power engine unit. The diameter of the wheel of the first system may be approximately 40 inches.

The second power engine unit may include transforming shaft 116-12 configured to convert into higher torque & higher speed. The second power engine unit may include gears 116-13 system configured to transform mechanical energy. The second power engine unit may include 116-14 configured to exert mechanical energy to the smaller piston of the follower cylinder system. The second power engine unit may include a follower cylinder system box 116-15 configured to form compression through compression oil lubricants. The follower cylinder system box is configured to convert mechanical energy to fluid energy. It contains a wider diameter cylinder to produce higher fluids energy.

The second power engine unit may include connecting rod 116-16 configured to transform fluid energy to mechanical with respect to follower cylinder system 116-15. The second power engine unit may include an iron plate 116-17 configured to hold the fourth system at ground or base level. The second power engine unit may include a large wheel 116-18 configured to transform mechanical energy to the fifth system. The diameter of the wheel 116-18 maybe 40 inches. The third power engine unit may include transforming crankshaft pully 116-19 configured to convert into higher torque & higher speed. It splits mechanical energy into two parts. One part of the mechanical energy is applied to the first system through a crankshaft and the second part of the mechanical energy is applied on the top center of the piston assembly of the second system. The third power engine unit may include transforming crankshaft 116-20 configured to transfer mechanical energy to the first system.

The third power engine unit may include connecting rod 116-21 configured to transform mechanical energy & exert on the top center of the second system. The third power engine unit may include gears 116-22 configured to transform mechanical energy. The third power engine unit may include flywheelcrankshaft 116-23 configured to transform mechanical energy. A penium shaft is associated with the crankshaft. The third power engine unit may include chamber 116-24 of the first system configured to hold the first system and associated parts.

The third power engine unit mayincludepiston 116-25 configured to transform mechanical into fluid energy concerning the compressor box. The piston 116-25 may be configured to exert the mechanical energy on compressive oil lubricants in the compressor system. In an exemplary embodiment, the diameter of piston 116-25 may be approx. 5 inch. In another exemplary embodiment, the diameter of the piston may be approx. 10 inch.

In an embodiment, the third power engine unit may include compressor systems116-26 to provide compression in between the first system and the second system. A compressive oil lubricant exerts two-way compressions with respect to the piston of the first system and pistons of the second system.

The third power engine unit may include piston assembly 116-27 of the second system, arranged in 3 rows and 4 columns. Total 12 pistons placed on top of the compressor system. The diameter of the piston of system2 is smaller as compared to the piston's diameter of system1. The piston's diameter may be approx. 2 inches. The piston's height may be approx. 4 inches of the second system.

The third power engine unit may include iron plate 116-28to hold the first system, second system, and third system of the third power engine unit on the ground or base level in the very efficient space & strong connecting slots. The third power engine unit may include a large wheel 116-29 configured to pass combined mechanical energy of the first system, second system, and third system of third power engine unit to the first of first power engine unit. It applies higher torque & higher speed to system1 of unit1. It allows continuous motion of the power engine, where each rotation cycle adds the higher torque & higher speed.

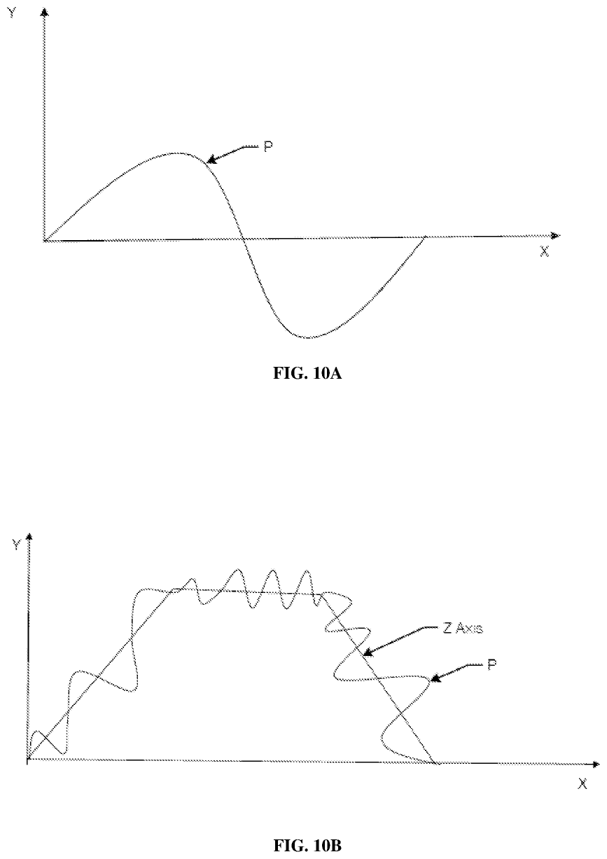

FIGS. 10A and 10B illustrate an exemplary representation of a waveform of power engine and mode of power engine, respectively, in accordance with embodiments of the present disclosure. As illustrated in FIGS. 10A and 10B, the horizontal axis represents time and the vertical axis represents energy, and thus the waveform represents the power of the power engine. In FIG. 10B, z coordinates present the mode of power through a linear portion.

The power of the power engine can be expressed in terms of internal power as P=|p*Sinx|, where p=internal power

In an embodiment, the mode of the power engine can be changed through gearbox and clutches. Further, with the gearbox and clutches, torque, speed, power of the power engine can be controlled and the power transfer and transformation can take place. The mode of power of the power engine can be represented as
1. Starting Mode: The starting mode lies between switched off of the system to starting of the system. Variable power in accordance with sine wave is exerted on the system in various ways. In an example, the power is exerted through any of manual operation through the handle, semi-manual operation by external devices, automatic operation by button pushes or pulls, and remote operation by web or mobile application.
2. Running Mode: The running mode lies between starting position to running position. The running mode is maintained through the flow of liquid such as lubricant oil in form of sine wave. A nozzle may provide liquid flow in form of sine wave. In this manner, constant sine wave power is exerted in the system. The increase in the lubricant flow may result in higher torque and power.
3. Stopping Mode: The stopping mode lies between the running position and the stopping position.

FIG. 11 illustrates an exemplary graphical representation of the power of the power engine unit, in accordance with embodiments of the present disclosure. The power of the power engine unit can be expressed as

Power(P)=c(x*y)

c representing power multiplier constant,
X-coordinate representing the amount of lubricants in a container,
Y-coordinate representing gears number, the dotted circle representing Power of power engine (P). In other words, the power of the power engine depends on the speed of flow of liquid with respect to gears applied and amount of liquid in the container system with respect to gears applied.

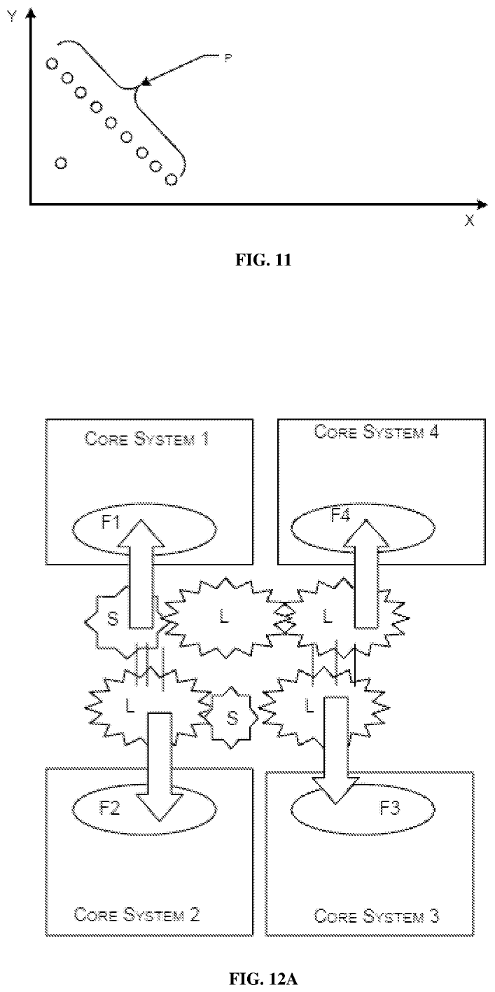

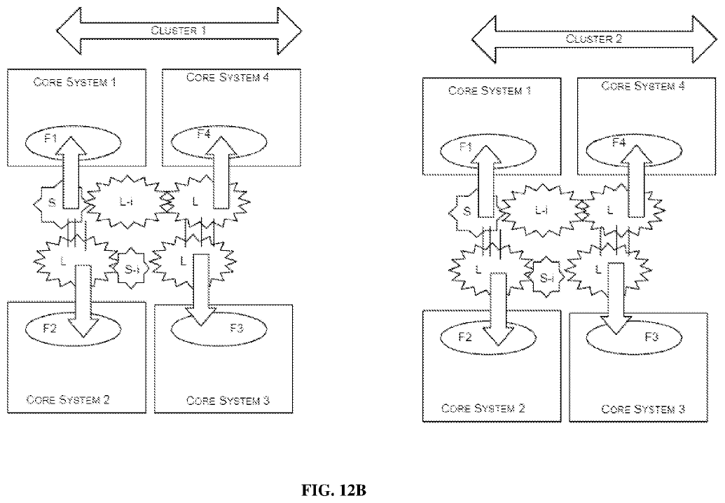

FIGS. 12A and 12B illustrate an exemplary representation of the clustering of the first core system, the second core system, the third core system, and the fourth core system, in accordance with embodiments of the present disclosure. As illustrated in FIG. 12, each of the first, second, third, and fourth core systems may include a flywheel F1, F2, F3, F4 respectively, through which systems are connected. There can be multiple such clusters that can be connected to form a large system as shown in FIG. 12B. The arrow represents the crankshaft of the corresponding system, whereas S and L represent small and large gear set respectively. Small thin three lines represent the connection between gears of two systems through the flywheel, whereas i represents intermediate gears for power transfer & transformation between core systems and clusters through clutches and gearbox.

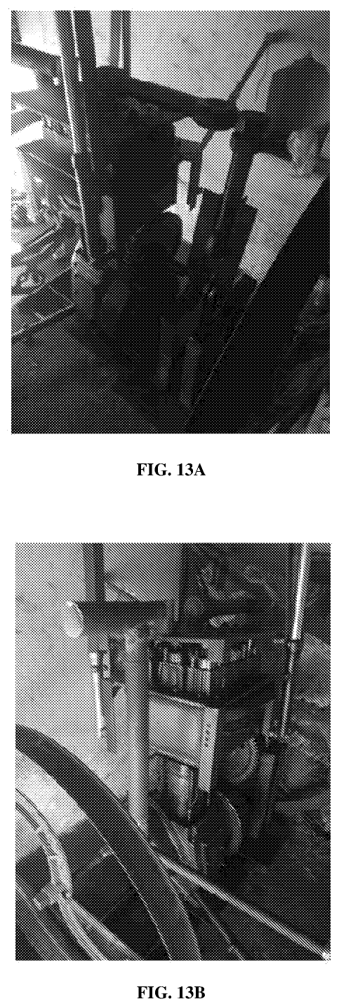

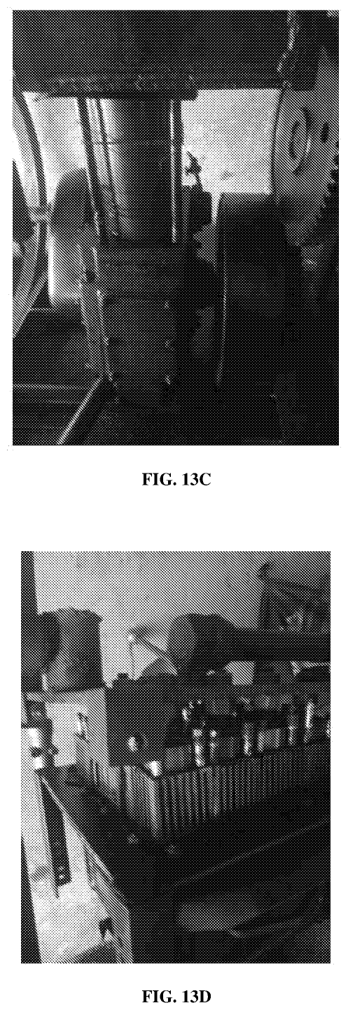

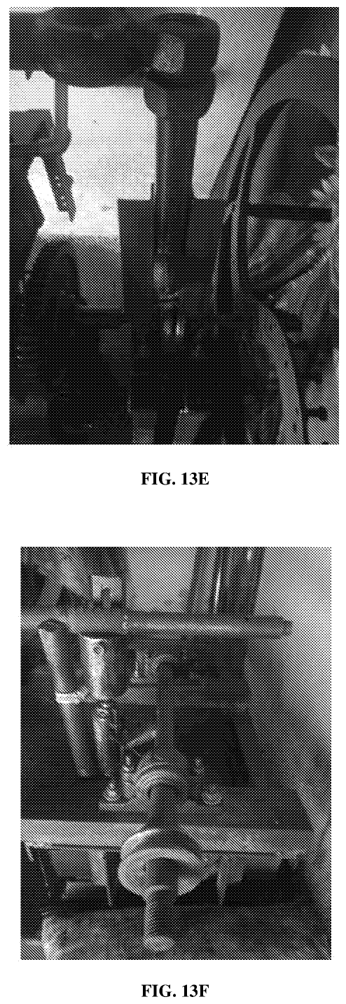

FIGS. 13A-13F illustrate various views of power engine, in accordance with embodiments of the present disclosure. FIG. 13A shows the initialization of the complete system process. It is a sample prototype of the front side view. It shows the integrated & connected systems front view.

FIG. 13B shows the initialization of the complete system process. It is a sample prototype of the backside view. It shows the integrated & connected systems back view. FIG. 13 C shows system 1. FIG. 13D illustrates system 2. FIG. 13E shows the system 3. FIG. 13F shows system 4.

In an embodiment, the power engine can be brought into a running state upon pressing the start button, or by rotating the handle of the first system 101. The power engine allows two-way input-output motions. To continue the power engine in running state, it doesn't require any petroleum-like diesel petrol gas, electric power, or external power. The present disclosure provides the power engine that is simple, portable, light weight, durable divided into the easy plug and play components. It can be easily operated. The proposed power engine can be used as a power source. For example, the power engine may include a generator that may convert mechanical energy to electrical energy, thereby acting as an electric source such as a battery. It can also be used in space, satellite. The power engine can be easily integrated with any kind of power source.

While the foregoing describes various embodiments of the invention, other and further embodiments of the invention may be devised without departing from the basic scope thereof. The invention is not limited to the described embodiments, versions, or examples, which are included to enable a person having ordinary skill in the art to make and use the invention when combined with information and knowledge available to the person having ordinary skill in the art.

I claim:

1. A power engine unit comprising:
a first system comprising a crankshaft wheel and the first set of cylinders, wherein the crankshaft flywheel is configured on one side of the first set of cylinders to provide a heavy circular output from the linear motion;
a second system comprising a second set of cylinders, and a set of pistons corresponding to the second set of cylinders, wherein the second set of cylinders are coupled to the first set of cylinders; and
a compressor system coupled with the first set of cylinders and the second set of cylinders, the compressor system comprising a first cylinder hole to allow the flow of compressor oil from the first set of cylinders of the first system.

2. The power engine unit as claimed in claim 1, wherein the power engine unit comprises a fourth system comprising a converter wheel coupled with the flywheel of the first system, where the coupling of the flywheel with the converter wheel allows the transfer of power from the first system to the fourth system.

3. The power engine unit as claimed in claim 2, wherein the power engine unit comprises a fifth system configured as a supporting power system and a sixth system configured as an additional power system.

4. The power engine unit as claimed in claim 1, wherein the first system includes a linear piston set to allow to &fro linear circular motion inside a cylinder chamber of the first set of cylinders, wherein the linear piston set is connected with the fourth system, and wherein the linear piston set is configured to perform push-pull movement inside the first set of cylinders with compressor oil.

5. The power engine unit as claimed in claim 1, wherein the first system includes a flywheel to couple with a heavy load of the pulley, gears, belt, chains as output system.

6. The power engine unit as claimed in claim 1, wherein the first system includes a penium shaft on another side of the first set of cylinders, wherein the penium shaft is configured with a handle, wherein the penium shaft is configured to convert the rotation of the handle into a linear movement to allow movement of the linear piston set inside the first set of cylinders.

7. The power engine unit as claimed in claim 1, wherein the second system includes a shocker spring configured to allow smooth movement of second set cylinders with a crankshaft flywheel.

8. The power engine unit as claimed in claim 5, wherein the second system includes connecting rod plates coupled with the shocker spring, wherein the connecting rod plates are configured to connect connecting rod of the second set of cylinders with each other, to collect the input-output power evenly.

9. The power engine unit as claimed in claim 1, wherein the second system includes a cylinder plate configured to hold the second set of cylinders.

10. The power engine unit as claimed in claim 1, wherein the second set of cylinders and corresponding pistons are arranged in rows and columns adjacent closed to each other, and wherein each of the second set of cylinders is smaller in size as compared to the first set of cylinders.
